(19) United States
(12) Patent Application Publication
(10) Pub. No.: US 2003/0024570 A1
(43) Pub. Date: Feb. 6, 2003

(54) Air hose

(76) Inventor: Jay A. Haman, Kerrville, TX (US)

Correspondence Address: John R. Casperson, PO Box 2174, Friendswood, TX, 77549, US

(21) Appl. No.: 09/920,367

(22) Filed: Aug. 1, 2001

(51) Int. Cl. F16K 15/20

(52) U.S. Cl. 137/231

(57) ABSTRACT

An emergency air hose suitable for inclusion in a roadside emergency kit comprises a coiled air hose having a locking connector on one end and a manually engagable connector on the other end.

### BACKGROUND OF THE INVENTION

This invention relates to an air hose for supplying air to the tires of a vehicle.

Vehicle tires must be properly aired to safely operate the vehicle. They occasionally become deflated or partially deflated at inopportune times, and require immediate attention. A fixed air source is not always available. Portable air pumps are bulky and relatively expensive, which discourages drivers from keeping them available. Pressurized containers of air are generally even more bulky and are difficult to secure in vehicles without trunks. Also, they don't always contain air. Pressurized small cans of emergency inflation gas and sealant constitute something of an explosion hazard and are generally incapable of providing more than the minimal amount of gas sufficient to move the vehicle to a fixed air source or a place of tire repair.

There exists a need for an airing device which is inexpensive, safe, and easily stored.

### SUMMARY OF THE INVENTION

In one embodiment of the invention, there is provided an airing device comprising air hose, a first connector, and a second connector. The air hose has a first end and a second end and a passage therethrough. The first connector is positioned on the first end of the air hose and is for connecting the air hose to a first vehicular tire air stem. The second connector is positioned on the second end of the air hose and is for connecting the air hose to a second vehicular tire air stem. In normal use, the airing device forms a flow passage between the first vehicular tire to the second vehicular tire via the first vehicular tire air stem and the second vehicular tire air stem.

In another embodiment of the invention, there is provided a method for airing a low tire. A releasable locking connector is connected to an air stem of the low tire. A manually engagable connector requiring a human operator to maintain a seal is then connected to a tire air stem which is operably connected to a pressure source of gas, generally air, at higher pressure than the low tire, enabling air to flow from the pressure source to the low tire. For example, a second tire which can be in or on the same vehicle as the low tire or on a different vehicle can be used as the air source. Alternatively, an air canister having a vehicular tire air stem fitting for charging the canister can be used as the air source.

The invention thus provides an inexpensive, compact and reliable device for meeting emergency airing needs.

### BRIEF DESCRIPTION OF THE DRAWINGS

FIG. 1 is a pictorial representation showing use of one embodiment of the invention.

FIG. 2 is a pictorial representation showing an embodiment of the invention in greater detail.

### DETAILED DESCRIPTION OF THE INVENTION

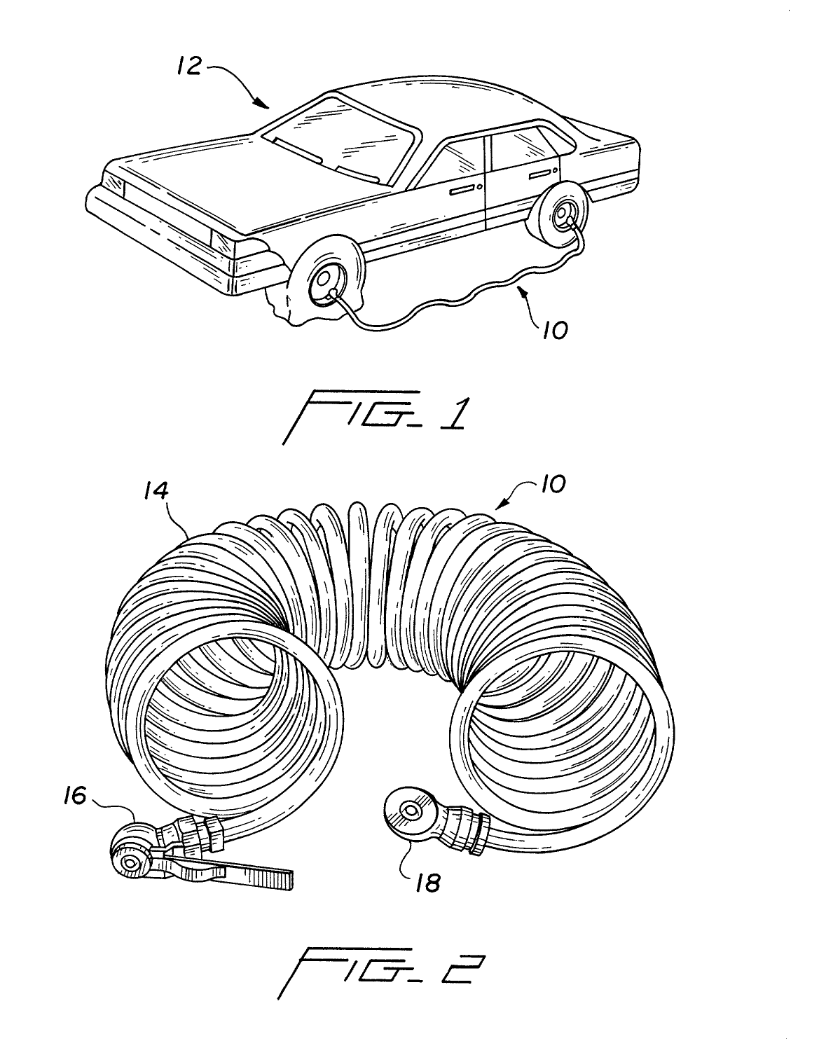

With reference to the drawings, an airing device 10 comprises air hose 14, a first connector 16, and a second connector 18. The air hose has a first end and a second end and a passage therethrough. The first connector is positioned on the first end of the air hose and is for connecting the air hose to a first vehicular tire air stem. The second connector is positioned on the second end of the air hose and is for connecting the air hose to a second vehicular tire air stem. In use, the airing device 10 forms a flow passage between the first vehicular tire and the second vehicular tire via the first vehicular tire air stem and the second vehicular tire air stem. The air stems can be on different tires of the same vehicle 12. See FIG. 1.

As shown in FIG. 2, the air hose is preferably constructed so as to relax into a coil when not in use to provide easy storage. A ¼ inch (ID) nylon recoil air hose having an extended length between 10 and 30 feet can be used with good results. Also as shown in FIG. 2, the first connector is preferably a releasable locking connector for releasably locking the first connector to the first vehicular tire air stem. A wide variety of releasable locking connectors are suitable. In the illustrated embodiment, the first connector clips onto the first vehicular tire air stem, so as to seal without being tended to by the operator, and to open the tire valve. A ball foot air chuck with clip will provide good results. The second connector is preferably manually engagable and requires a human operator to maintain a seal on the second vehicular tire air stem. This enables the operator to move from tire to tire if necessary to balance pressures and/or adequately air the low tire without excessively deflating the aired tires. Generally speaking, the second connector has to be pushed against the second vehicular tire air stem to form a seal and open the valve to permit air to flow. A ball foot air chuck can be used with good results.

In use, a first vehicular tire containing air at a first pressure is in flow arrangement with the first vehicular tire air stem. The first connector is connected to the first vehicular tire air stem. A second vehicular tire containing air at a second pressure higher than the first pressure is in flow arrangement with the second vehicular tire air stem. The second connector is connected to the second vehicular tire air stem. Air can then flow from the second tire to the first, until the pressures equalize. The air pressure in the second vehicular tire can vary over a wide range. Generally speaking, it will be in the range of 10 psig to 100 psig, usually between 20 and 40 psig for passenger cars and light trucks.

In use, a releasable locking connector such as that previously described is connected to an air stem of the low tire. A manually engagable connector requiring a human operator to maintain a seal, such as that previously described, is then connected to a tire air stem which is operably connected to a pressure source of air at higher pressure than the low tire, enabling air to flow from the pressure source to the low tire. This can be a second tire which can be in or on the same vehicle as the low tire, or on a different vehicle, or, for example, an air canister. Usually, however, the pressure source will be an aired tire on the same vehicle as the low tire.

While certain preferred embodiments of the invention have been described herein, the invention is not to be construed as being so limited, except to the extent that such limitations are found in the claims.

What is claimed is:

1. Apparatus comprising
an air hose having a first end and a second end and a passage therethrough,
a first connector positioned on the first end of the air hose for connecting the air hose to a first vehicular tire air stem,
a second connector positioned on the second end of the air hose for connecting the air hose to a second vehicular tire air stem,
so as to form a flow passage between the first vehicular tire to the second vehicular tire via the first vehicular tire air stem and the second vehicular tire air stem.

2. Apparatus as in claim 1 wherein the air hose is constructed so as to relax into a coil when not in use to provide easy storage.

3. Apparatus as in claim 1 wherein
the first connector is a releasable locking connector for releasably locking the first connector to the first vehicular tire air stem, and
the second connector is a manually engagable connector requiring a human operator to maintain a seal on the second vehicular tire air stem.

4. Apparatus as in claim 3 wherein the first connector clips onto the first vehicular tire air stem.

5. Apparatus as in claim 4 wherein the second connector seals against the second vehicular tire air stem when manually pushed against the second vehicular tire air stem.

6. Apparatus as in claim 5 further comprising a first vehicular tire containing air at a first pressure in flow arrangement with the first vehicular tire air stem, wherein the first connector is connected to the first vehicular tire air stem.

7. Apparatus as in claim 6 further comprising a second vehicular tire containing air at a second pressure higher than the first pressure in flow arrangement with the second vehicular tire air stem, wherein the second connector is connected to the second vehicular tire air stem.

8. A method for airing a low tire comprising
connecting a releasable locking connector to an air stem of the low tire, and
manually engaging a manually engagable connector requiring a human operator to maintain a seal on a tire air stem connected to a pressure source of air at higher pressure than the low tire, whereby air flows from the pressure source to the low tire.

9. A method as in claim 8 wherein the pressure source is an aired tire.

10. A method as in claim 9 wherein the low tire and the aired tire are on a motor vehicle.
